(19) United States
(12) Patent Application Publication
(10) Pub. No.: US 2011/0298830 A1
(43) Pub. Date: Dec. 8, 2011

(54) Single Point Input Variable Zoom

(75) Inventor: Yin Zin Mark Lam, Milpitas, CA (US)

(73) Assignee: PALM, INC., Sunnyvale, CA (US)

(21) Appl. No.: 12/795,447

(22) Filed: Jun. 7, 2010

(51) Int. Cl. G09G 5/00

(52) U.S. Cl. 345/661; 345/173

(57) ABSTRACT

A method and computer readable medium are disclosed for re-sizing screen content of a user interface comprising an initial view displayed within a touch-sensitive screen. A double tap and hold interaction is detected on the screen at an initial location. A drag interaction is detected, where the drag interaction comprises maintaining contact across the screen in an initial direction. A release interaction is detected, where the release interaction comprises a final location where interaction on the screen is detected. A zoom factor is determined based upon the initial location, the final location, and the initial direction. A zoomed view is generated using the zoom factor, where the zoomed view changes a proportion of the screen filled by an area surrounding the initial location relative to the initial view. Finally, the zoomed view of the screen content is provided for display on the screen.

### BACKGROUND

1. Field of Art

The disclosure generally relates to the field of input methodology used with visual presentation on screens, and more specifically, to changing the scale of visual presentation on screens.

2. Description of Art

Computing devices with small screens, for example, smartphones and functionality enhanced mobile phones, are well known. Such computing devices include screens with application user interfaces that display information (including information attained from a remote source over a network), for example, web browser pages or applets. These user interfaces may have a large volume of information compressed to fit within the small area of the mobile device screen. Moreover, the screens are configured to be touch sensitive to allow direct interaction with the user interface through the screen.

One problem with having so much information compressed into such a small screen area is that the information can be difficult to interact with and read. Often, the only means of increasing the size of such information is if the provider of the network and application user interface specifically designs or optimizes the user interface to be used on a small screen device.

One attempt to address the shortcomings of the art has been to allow a user to manually increase the zoom of the screen content of a user interface being rendered using a two point gesture. However, invoking that two point zoom gesture in conventional systems requires that two points of contact (i.e., two fingers) be made with the screen in order to perform the zoom function, which is cumbersome for one handed operation. Another attempt to address the shortcomings of the art has been to allow the user to perform a double tap zoom on an area of interest. However, this does not allow the user to have fine grain control on the zoom level, nor does it allow them to specify the zoom direction. Some solutions make use of zoom scroll bars or zoom buttons, however these solutions do not allow the user to specify the focal point of where the zoom will occur. Moreover, many user interfaces still lack mechanisms to allow zooming.

Hence, the art lacks, inter alia, a mechanism for manual, variable zooming over a focal point (e.g., user specified) that requires only a single input point of contact with the screen.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1a illustrates one embodiment of a mobile computing device in a first positional state.

FIG. 1b illustrates one embodiment of the mobile computing device in a second positional state.

FIG. 2 illustrates one embodiment of an architecture of a mobile computing device.

FIG. 3 illustrates one embodiment of an architecture for performing a zoom on the screen content of a user interface based on a touch action.

FIG. 4a illustrates one embodiment of an example of zoom and the data that can be extracted from a touch action.

FIG. 4b illustrates one embodiment of another example of a zoom.

FIG. 5 illustrates one embodiment of a process for zooming screen content based on a touch action.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Configuration Overview

One embodiment of a disclosed system (or apparatus or method or computer readable storage medium) includes recognizing a single point input variable zoom gesture configured to modify the size of screen content rendered within a touch sensitive screen. By way of example, in one embodiment a system is configured to zoom screen content of a user interface displayed within a touch-sensitive screen. The screen content comprises an initial view. The system provides the screen content for display on the touch sensitive screen.

The system detects a double tap and hold interaction on the touch sensitive screen. The double tap and hold interaction comprises making an initial touch and release of the screen followed quickly by a second touch without release in the same initial location, and maintaining contact with the screen at that initial location for a predetermined period of time (e.g., zero or more seconds). Using the initial location, the system identifies a focal point where the double tap and hold interaction occurred. The system then detects a drag interaction, where the drag interaction comprises maintaining constant contact on the screen while moving the contact point. The system determines an initial direction from the initial movement of the drag interaction.

Using the focal point and the initial direction, the system determines a zoom axis. The zoom axis is perpendicular to the initial direction and passes through the initial location of the focal point. Using the zoom axis, the system determines a zoom-in plane, which is a portion of the screen in the initial direction, bounded by the zoom axis. The system also uses the zoom axis to determine a zoom-out plane, which is a portion of the screen not in the initial direction, e.g., opposite direction, bounded by the zoom axis. The system detects a zoom gesture that may move in any direction around the screen. Optionally, responsive to the drag interaction the system may provide for display on the screen a visual preview of the zoom. The visual preview provides visual feedback on the magnitude and direction of the zoom as the zoom gesture moves around the screen.

The system detects a release interaction, which comprises a final location where the constant contact with the screen ends. The system determines a zoom factor based upon the initial location, the final location, and the initial direction. The system generates a zoomed view using the zoom factor. The zoomed view changes the proportion of the screen filled by an area surrounding the focal point relative to the initial view. The system provides a zoomed view version of the screen content for display on the screen.

### Example Mobile Computing Device

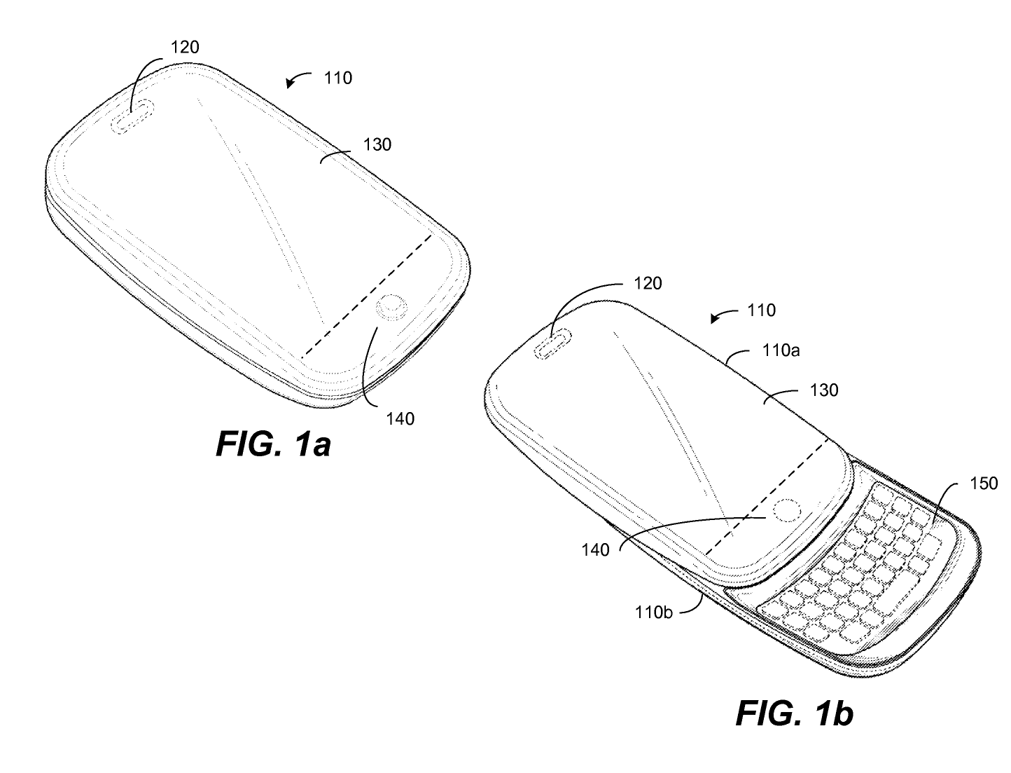

In one example embodiment, the configuration as disclosed may be configured for use with any computing device having a screen, particularly a small form factor screen such as one found on a smartphone, media player or tablet computer. For ease of discussion, the embodiments disclosed will be described in the context of a mobile computing device, but would be applicable to other computing devices having screens, particularly those with touch sensitive screens. FIGS. 1a and 1b illustrate one embodiment of a mobile computing device 110. FIG. 1a illustrates one embodiment of a first positional state of the mobile computing device 110 having telephonic functionality, e.g., a mobile phone or smartphone. FIG. 1b illustrates one embodiment of a second positional state of the mobile computing device 110 having telephonic functionality, e.g., a mobile phone, smartphone, netbook, or laptop computer. The mobile computing device 110 is configured to host and execute a phone application for placing and receiving telephone calls.

It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) and/or data networks having voice over internet protocol (VoIP) functionality. The principles disclosed herein may also be applied to devices lacking telephonic functionality.

Likewise, the mobile computing device 110 is only by way of example, and the principles of its functionality apply to other computing devices, e.g., tablet computers, laptop computers, notebook computers, netbook computers, desktop computers, server computers, media players, and the like, particularly those having touch sensitive screens. The principles disclosed herein also apply to computing devices with attached pointer input devices. In these embodiments, the described touch interactions would be equivalent to click or button press interactions, for example via a mouse in the case of click interactions.

The mobile computing device 110 includes a first portion 110a and a second portion 110b. The first portion 110a comprises a screen for display of information (or data) and may include navigational mechanisms. These aspects of the first portion 110a are further described below. The second portion 110b comprises a keyboard and also is further described below. The first positional state of the mobile computing device 110 may be referred to as an “open” position, in which the first portion 110a of the mobile computing device slides in a first direction exposing the second portion 110b of the mobile computing device 110 (or vice versa in terms of movement). The mobile computing device 110 remains operational in either the first positional state or the second positional state.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 15 centimeters in width, 0.5 to 2.5 centimeters in thickness and weigh between 50 and 250 grams.

The mobile computing device 110 includes a speaker 120, a screen 130, and an optional navigation area 140 as shown in the first positional state. The mobile computing device 110 also includes a keypad 150, which is exposed in the second positional state. The mobile computing device also includes a microphone (not shown). The mobile computing device 110 also may include one or more switches (not shown). The one or more switches may be buttons, sliders, or rocker switches and can be mechanical or solid state (e.g., touch sensitive solid state switch).

The screen 130 of the mobile computing device 110 is, for example, a 240×240, a 320×320, a 320×480, or a 640×480 touch sensitive (including gestures) display screen. The screen 130 can be structured from, for example, such as glass, plastic, thin-film or composite material. The touch sensitive screen may be a transflective liquid crystal display (LCD) screen. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the screen displays color images. In another embodiment, the screen 130 further comprises a touch-sensitive screen (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The optional navigation area 140 is configured to control functions of an application executing in the mobile computing device 110 and visible through the screen 130. For example, the navigation area includes an x-way (x is a numerical integer, e.g., 5) navigation ring that provides cursor control, selection, and similar functionality. In addition, the navigation area may include selection buttons to select functions displayed through a user interface on the screen 130. In addition, the navigation area also may include dedicated function buttons for functions such as, for example, a calendar, a web browser, an e-mail client or a home screen. In this example, the navigation ring may be implemented through mechanical, solid state switches, dials, or a combination thereof. In an alternate embodiment, the navigation area 140 may be configured as a dedicated gesture area, which allows for gesture interaction and control of functions and operations shown through a user interface displayed on the screen 130.

The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards). Examples of memory or media card form factors include COMPACTFLASH, SD CARD, XD CARD, MEMORY STICK, MULTIMEDIA CARD, SDIO, and the like.

### Example Mobile Computing Device Architectural Overview

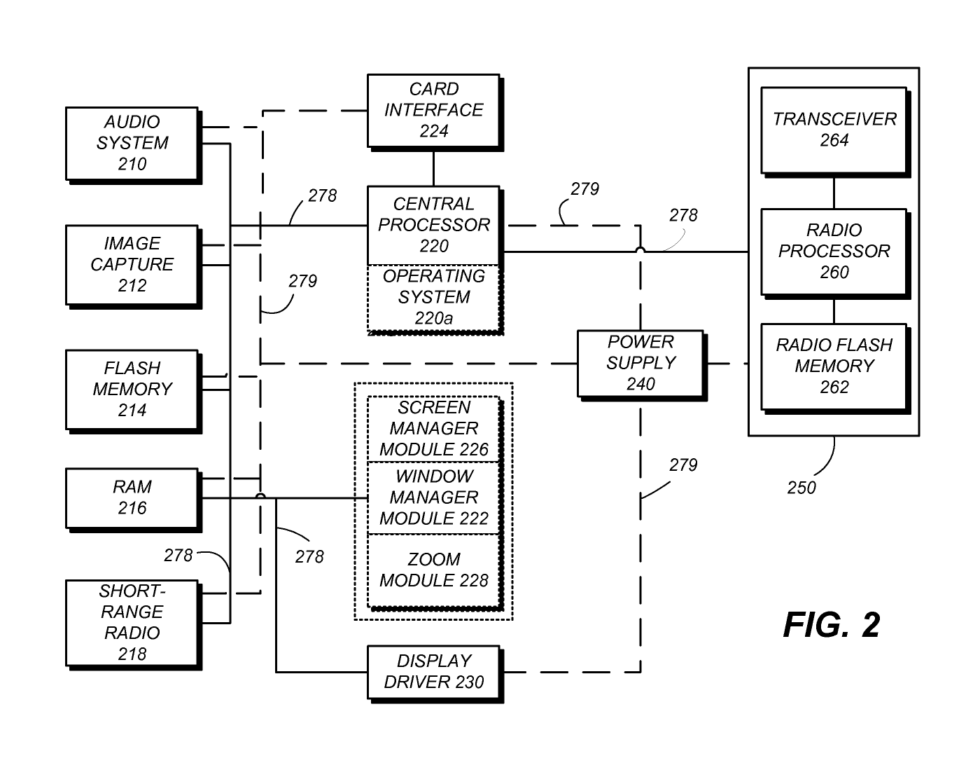

Referring next to FIG. 2, a block diagram illustrates one embodiment of an architecture of a mobile computing device 110, with telephonic functionality. By way of example, the architecture illustrated in FIG. 2 will be described with respect to the mobile computing device of FIGS. 1a and 1b. The mobile computing device 110 includes one or more processors 220 (collectively referred to as a processing system, central processing core or central processor for ease of discussion), a power supply 240, and a radio subsystem 250. Examples of a central processor 220 include processing chips and system based on architectures such as ARM (including cores made by microprocessor manufacturers), ARM XSCALE, AMD ATHLON, SEMPRON or PHENOM, INTEL ATOM, XSCALE, CELERON, CORE, PENTIUM or ITANIUM, IBM CELL, POWER ARCHITECTURE, SUN SPARC and the like.

The central processor 220 is configured for operation with a computer operating system. The operating system is an interface between hardware and an application, with which a user typically interfaces. The operating system is responsible for the management and coordination of activities and the sharing of resources of the mobile computing device 110. The operating system provides a host environment for applications that are run on the mobile computing device 110. As a host, one of the purposes of an operating system is to handle the details of the operation of the mobile computing device 110. Examples of an operating system include PALM OS and WEBOS, MICROSOFT WINDOWS (including WINDOWS 7, WINDOWS CE, and WINDOWS MOBILE), SYMBIAN OS, RIM BLACKBERRY OS, APPLE OS (including MAC OS and IPHONE OS), GOOGLE ANDROID, and LINUX.

The central processor 220 communicates with an audio system 210, an image capture subsystem (e.g., camera, video or scanner) 212, flash memory 214, RAM memory 216, and a short range radio module 218 (e.g., Bluetooth, Wireless Fidelity (WiFi) component (e.g., IEEE 802.11)). The central processor communicatively couples these various components or modules through a data line (or bus) 278. The power supply 240 powers the central processor 220, the radio subsystem 250 and a display driver 230 (which may be contact- or inductive-sensitive). The power supply 240 may correspond to a direct current source (e.g., a battery pack, including rechargeable batteries) or an alternating current (AC) source. The power supply 240 powers the various components through a power line (or bus) 279.

The central processor 220 communicates with applications executing within the mobile computing device 110 through the operating system 220a. In addition, intermediary components, for example, a window manager module 222 and a screen manager module 226, provide additional communication channels between the central processor 220 and operating system 220 and system components, for example, the display driver 230.

In one embodiment, the window manager module 222 comprises a software (e.g., integrated with the operating system) or firmware (lower level code that resides is a specific memory for that code and for interfacing with specific hardware, e.g., the processor 220). The window manager module 222 is configured to initialize a virtual display space, which may be stored in the RAM 216 and/or the flash memory 214. The virtual display space includes one or more applications currently being executed by a user and the current status of the executed applications. The window manager module 222 receives requests, from user input or from software or firmware processes, to show a window and determines the initial position of the requested window. Additionally, the window manager module 222 receives commands or instructions to modify a window, such as resizing the window, moving the window or any other command altering the appearance or position of the window, and modifies the window accordingly.

The screen manager module 226 comprises a software (e.g., integrated with the operating system) or firmware. The screen manager module 226 is configured to manage content that will be displayed on the screen 130. In one embodiment, the screen manager module 226 monitors and controls the physical location of data displayed on the screen 130 and which data is displayed on the screen 130. The screen manager module 226 alters or updates the location of data as viewed on the screen 130. The alteration or update is responsive to input from the central processor 220 and display driver 230, which modifies appearances displayed on the screen 130. In one embodiment, the screen manager 226 also is configured to monitor and control screen brightness. In addition, the screen manager 226 is configured to transmit control signals to the central processor 220 to modify power usage of the screen 130.

A zoom module 228 comprises software that is, for example, integrated with the operating system 220a or configured to be an application operational with the operating system 220a. In some embodiments it may comprise firmware, for example, stored in the flash memory 214. The zoom module 228 is configured to detect a single point, manual, variable zoom action (herein referred to as a “zoom action”) and zoom (or enlarge, magnify, re-size, scale, compress, or shrink) the rendered screen content of the user interface based on the measured properties of the detected zoom action.

It is noted that in one embodiment, central processor 220 (e.g., one or more processors) executes logic (e.g., by way of programming, code, or instructions) corresponding to executing applications interfaced through, for example, the navigation area 140 or switches 170. It is noted that numerous other components and variations are possible to the hardware architecture of the computing device 200, thus an embodiment such as shown by FIG. 2 is just illustrative of one implementation for an embodiment. The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120 (or 184). The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) and fourth-generation (4G) mobile (or greater), Long Term Evolution (LTE), High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using the data line (or bus) 278.

The card interface 224 is adapted to communicate, wirelessly or wired, with external accessories (or peripherals), for example, media cards inserted into the expansion slot (not shown). The card interface 224 transmits data and/or instructions between the central processor and an accessory, e.g., an expansion card or media card, coupled within the expansion slot. The card interface 224 also transmits control signals from the central processor 220 to the expansion slot to configure the accessory. It is noted that the card interface 224 is described with respect to an expansion card or media card; it also may be structurally configured to couple with other types of external devices for the device 110, for example, an inductive charging station for the power supply 240 or a printing device.

By way of example, in one embodiment the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, the modules are persistently (e.g., non-transitorily) stored on the computer-readable storage devices of the mobile device or server system, loaded into memory, and executed by the one or more processors.

### Zoom Module

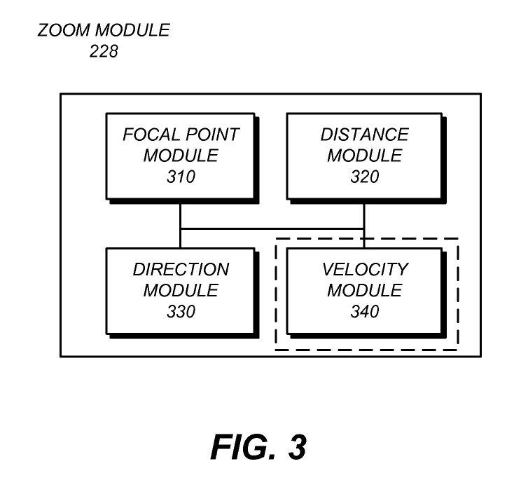

FIG. 3 illustrates one embodiment of a logical view of the zoom module 228. As previously noted, the zoom module 228 is configured to detect a single point, manual, variable zoom action and magnify or compress the screen content of a user interface based on the measured properties of the detected zoom action. The zoom module 228 comprises a focal point module 310, a distance module 320 and a direction module 330, all communicatively coupled. Optionally, the zoom module 228 additionally comprises a velocity module 340, which also is communicatively coupled.

The focal point module 310 is configured to detect an initiating action (or interaction). The initiating action indicates that a zoom action will follow. Together, the first touch and the zoom gesture provide all the information that is needed by the zoom module 228 to perform the zoom action. The initiation action and completion action are bounding events that signal when the zoom module 228 is to be used to perform a zoom action (e.g., zoom in or zoom out).

The initiating action can take the form of a single point touch action by a finger (or some object corresponding to triggering the touch sensitive screen such as a stylus or touch screen pen). For example, the initiating action may be a single or double tap of a finger. Following the initiating action, a first touch establishes the focal point at that location on the screen 130.

The initiating action may be of a different form than just a single or double tap on the screen 130. This might be the case where the touch sensitive screen 130 has already reserved the single or double tap action for purposes other than the described single point input variable zoom. The initiating action may comprise, for example: pressing and holding down on a physical button 150 while making the first touch on the screen 130; pressing and holding down a virtual button 140 or locus on the surface while making the first touch; pressing and releasing a pre-designated physical button(s) 150 before making the first touch; pressing and releasing a pre-designated virtual button 140 or locus on the surface before making the first touch; making a menu selection to enter zoom mode before making the first touch; touching and holding on the screen 130 to bring up a context menu which includes an option to enter zoom mode, selecting zoom mode, and proceeding to make the first touch; and/or issuing a voice command to enter zoom mode before making the first touch.

After detecting an initiating action, the focal point module 310 detects a first touch on the screen 130 which establishes a focal point at that location on the screen 130. In one embodiment, the first touch comprises the single or double tap that served as the initiating action followed by constant contact with the touch sensitive screen 130, without releasing that contact until a subsequent zoom gesture and completion action occur. Hence, the location of the initiating action defines the location of the first touch. In another embodiment, the first touch is a tap or a tap and hold for a predetermined period of time (e.g., zero or more seconds) on the touch sensitive screen 130 after the contact of the initiating action has been released. Hence, the specification of the location of the focal point can be performed independently from the initiating action.

The focal point comprises at least a set of coordinates indicating the location of the first touch on the screen 130. Relative to the subsequent zoom gesture, the focal point establishes a zero point for the amount and direction of zoom. The focal point is used by the direction module 330 to define a zoom axis where if the zoom gesture crosses the zoom axis, the zoom mode switches from zoom-in to zoom-out, or vice versa. The focal point is used by the distance module 320 in conjunction with a release point of the completion action to determine the amount to zoom the screen content.

The direction module 330 is configured to detect a zoom gesture on the screen 130 in order to determine the zoom axis that dictates which direction a zoom gesture must move to switch between zoom-in mode and zoom-out mode. Using the focal point from the focal point module 310 as a starting point, the direction module 330 detects a zoom gesture originating at the focal point and moving in an initial drag direction. Once the initial drag direction is determined, a zoom axis is established perpendicular to the initial drag direction. The zoom axis demarcates a boundary whereby if the zoom gesture passes over the zoom axis, the zoom mode switches from zoom-in to zoom-out mode.

In one embodiment, the portion of the screen 130 in the direction of the initial drag direction bounded by the zoom axis is the zoom-in plane. The portion of the screen 130 not in the direction of the initial drag direction again bounded by the zoom axis is the zoom-out plane. In another embodiment, the zoom-out plane is the portion of the screen 130 in the direction of the initial drag direction, and the zoom-in plane is the portion of the screen 130 not in the direction of the initial drag direction.

In other embodiments, the direction module 330 does not use the initial drag direction to determine which portions of the screen are the zoom-in and zoom-out planes. In these embodiments, the zoom axis, zoom-in plane and zoom-out plane are pre-defined independent of the initial drag direction. In one such embodiment, the zoom axis is determined to be a vertical line through the focal point, the zoom-in plane is the portion of the screen 130 to the right of the zoom axis, and the zoom-out plane is the portion of the screen 130 to the left of the zoom axis. In another embodiment, the zoom axis is determined to be a horizontal line through the focal point, the zoom-in plane is the portion of the screen above the zoom axis, and the zoom-out plane is the portion of the screen below the zoom axis. Other embodiments with different permutations and a similar fixed zoom axis which is independent of the initial drag direction are also possible.

The distance module 320 is configured to detect a zoom gesture to determine the amount of zoom that will be applied to the screen content. Using the focal point as a starting point, the distance module 320 determines a length measure indicating the distance between the focal point and current location of the zoom gesture on the screen 130. As the zoom gesture continues and the point of contact with the screen 130 moves around, the distance module recalculates the length measure. The length measure determines how much to zoom-in or zoom-out the screen content of the user interface.

In one embodiment, as the zoom gesture continues, the distance module 320 creates a visual preview of what the zoom would look like if it was applied to the screen content based on the current location of the zoom gesture. To generate the visual preview, the distance module 320 communicates with the direction module 330 to determine whether the zoom gesture is currently in the plane of zoom-in or the plane of zoom-out. Based upon which plane the zoom gesture is currently located and the length measure at that instant in time, the direction module 320 creates a visual preview of the zoom to the screen content. As the zoom gesture moves around the screen, the zoom is updated. The preview of the zoom makes it appears as if the zoom is being applied radially outward from the focal point.

The distance module 320 is further configured to detect a completion action, indicating that the user is finished with the zoom gesture and wishes to have the zoom finalized and applied to the screen content of the user interface. The completion action comprises a release point indicating the final location of the zoom gesture. The release point comprises at least a set of coordinates on the screen 130. Once the completion action is detected, the distance module 320 makes a final calculation of the length measure between the focal point and the release point. The distance module 320 also communicates with the direction module 330 to determine whether the release point is in the zoom-in plane or zoom-out plane.

Together with the length measure and the plane of the release point, the distance module 320 can zoom the screen content of the user interface. In one embodiment, the distance module 320 communicates with the screen manager module 226 and the window manager module 222 to zoom the user interface. The amount of zoom is determined by the length measure, and whether to zoom the user interface in or out depends on whether the release point was in the zoom-in or zoom-out plane. The zoom is applied by re-rendering the screen content at a new magnification based on the zoom amount and zoom direction, centered around the focal point. The zoom is applied and the screen content is re-rendered on the screen 130. In an alternate embodiment, the distance module 320 can directly re-render the zoomed screen content.

In one embodiment, the completion action is the release of constant contact, of a touch by a finger, a stylus, or touch pen, on the screen 130. The point where the release of the contact occurs is the release point. In another embodiment, the completion action is the release of constant contract for more than a predetermined amount of time. For example, the completion action occurs when the contact from the screen 130 is disengaged (or released) and does not touch the screen again within, a predetermined time period, for example, one second. If the screen is reengaged with a touch within the predetermined period, the zoom gesture resumes at the point where the user touches the screen 130 again. It is noted that other completion actions are envisioned, for example, the completion action may require the user to touch a virtual 140 or physical 150 button on the mobile computing device 110. The breadth of different interactions that may comprise the completion event mirror the examples provided above for the initiation action above.

In one embodiment, the zoom amount (or quantity) is a linear function of the length measure. In other embodiments, the zoom amount may be an exponential function of the length measure, a stepped function of the length measure, or a custom curve that changes as a function of the length measure. In another embodiment, the zoom amount is computed as the perpendicular distance between the zoom gesture and the zoom axis.

In one embodiment, the distance module 320 is configured to obtain additional screen content from the user interface to display. This may be invoked when the zoom action is a zoom in action, and the zoom amount is large enough such that the screen can appropriately display additional, smaller scale (or finer granularity) screen content that was not present in the initial un-zoomed view of the screen content. The finer granularity content may have been left out of the previous display of the user interface based on application or user preference, or because of screen constraints and the confusion that would arise from packing too much information into too small a space. The distance module 320 determines what additional content is appropriate to display in the new zoom view based on the zoom amount, the additional content to be displayed, and any instructions from the user interface.

In another embodiment, the distance module 320 is configured to select which information will be displayed in the zoomed view of the screen content of the user interface. This may be invoked when the zoom action is a zoom out action, and the zoom amount is large enough such that the screen cannot appropriately display all of the screen content that the user interface displayed in the un-zoomed view. For example, the un-zoomed view may display detailed content that is obscured when viewed from the perspective of the zoomed view. The distance module 320 is configured to remove smaller scale (or finer granularity) content when determining what screen content to display in the zoomed view. The distance module 320 determines what screen content to remove from the display based on the zoom amount, the granularity level of the content that was displayed in the initial view, and any instructions from the user interface.

The optional velocity module 340 is configured to modify the result of the distance module 320 to take into account the velocity of the zoom gesture when calculating the amount of zoom to be applied to the screen content of the user interface. Rather than calculating the amount of zoom based on only the length measure between the release point and the focal point, the velocity module 340 modifies the length measure by a factor based on the velocity of the zoom gesture between the focal point and the release point. The velocity of the zoom gesture is determined by measuring the zoom gesture as it moves across the touch sensitive screen 130, and recording the amount of time and the distance between two points of the zoom gesture. This measurement can be updated in real time, to determine an instantaneous velocity of the zoom gesture as it moves around the screen.

In one embodiment, the preview of the zoom amount takes into account the modification of the zoom amount by the velocity module 340. In some embodiments, the zoom gesture must achieve a predetermined minimum velocity in order to activate the velocity module 340.

The greater the velocity achieved by the zoom gesture between the focal point and the release point, the larger the factor of the zoom. For example, the amount of zoom may be multiplied from its base amount by a factor between one and five depending upon the velocity of the zoom gesture movement at that moment. Alternatively, it is contemplated that the user may wish to fine tune the zoom after reaching high speed in a single direction with the zoom gesture. In one embodiment, the velocity module 340 only keeps track of the highest measured speed of the current zoom gesture. The zoom amount is modified by a factor associated with this highest measured speed. Thus, if the zoom gesture subsequently moves slower than the highest measured speed, the zoom factor is unchanged unless the zoom gesture later moves more quickly than the previously highest measured speed. This facilitates fine zoom control once a high speed has been reached.

### Zoom Example

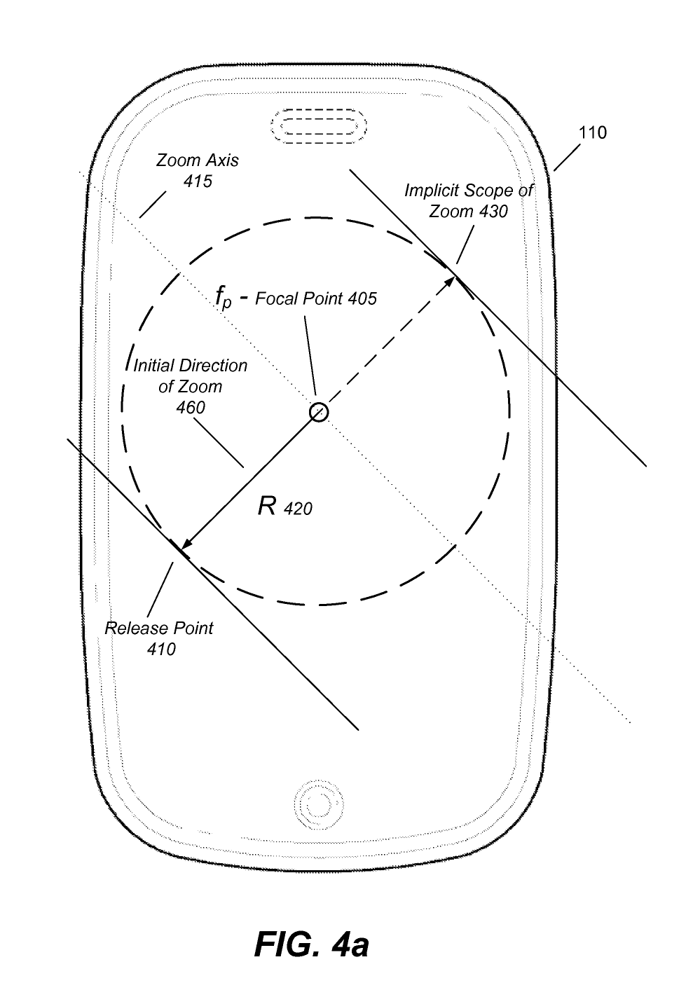

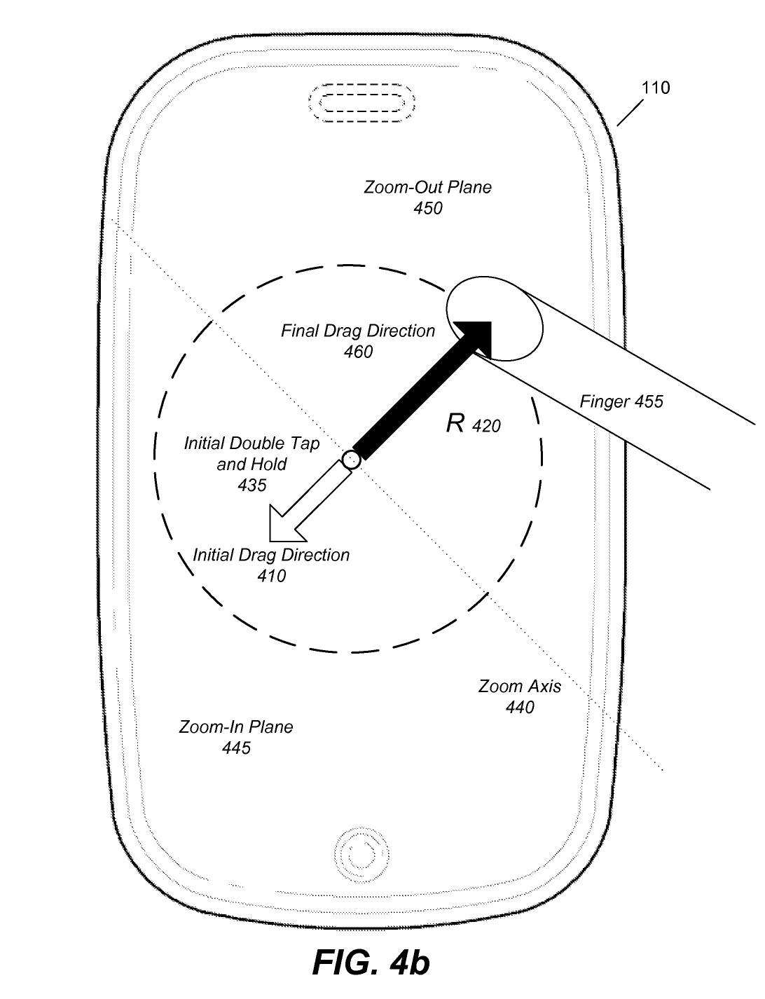

FIGS. 4a and 4b illustrate one embodiment of an example touch sensitive screen 130 displaying a user interface configured to implement a single input variable zoom action as described above. Generally, other than a preview of the zoom amount and direction, none of the lines or circles that appear in FIG. 4a or 4b necessarily need to appear on the screen 130, rather they are merely explanatory. FIG. 4a illustrates how the screen 130 is divided based on the location of the focal point, and the various distances, lines, and planes defined in order to determine the zoom to be performed on the screen content. In the example of FIG. 4a, the zoom gesture comprises a user dragging the zoom gesture in only a single direction from the focal point fₚ 405 before the completion event occurs at release point 410.

As a drag of the zoom gesture is detected on the screen 130 in the initial direction 435 towards the release point 410, the zoom axis 415 is established perpendicular to the initial direction 460. The length measure, labeled as ‘R’ 420 (where R is a radius), represents the distance between the release point 410 and the focal point 405. The length measure is defined as ‘R’ because the zoom module 228 zooms the screen content radially outward from the focal point 405. Thus, the implicit scope of the zoom 430 is double the length measure, extending both directions from the focal point 405. The zoom amount is computed as a function of ‘R’ 420. The dotted circle touching both the release point 410 and the opposite point of the implicit scope of zoom 430 represents that the zoom is centered around the focal point 405.

FIG. 4b illustrates an example of a zoom action where the zoom gesture moves in an initial direction 410, and then changes direction and moves in a final direction 460 in order to change the zoom mode. In the embodiment of the example of FIG. 4b, the zoom action is initiated (e.g., by a user) by double tapping and holding 435 the touch sensitive screen 130 with their finger 455. The finger 455 drag is detected in an initial drag direction 410 to establish the zoom axis 440 perpendicular to the initial zoom direction 410. In this embodiment, the zoom-in plane 445 is defined as the portion of the screen 130 on the same side as the initial drag direction 410, bounded by the zoom axis 440. The zoom-out plane 450 is defined as the portion of the screen 130 on the opposite side of the screen 130 from the initial drag direction 410, bounded by the zoom axis 440. In FIG. 4b, the initial drag direction 410 is determined to perform a zoom-in action. This case is merely an example, in another embodiment the initial drag direction 410 could have been defined to perform a zoom-out action instead. Continuing with the example of FIG. 4b, in order to perform a zoom-out action, a change in direction on the screen 130 with their finger 455 is detected, and the zoom axis 440 is crossed in a final drag direction 460. The amount of zoom 420 is determined, e.g., by the distance of the drag, and until release of the finger 455 is detected. The result is a zoom-out of the screen content based on the amount of zoom 420.

### Zoom Operation

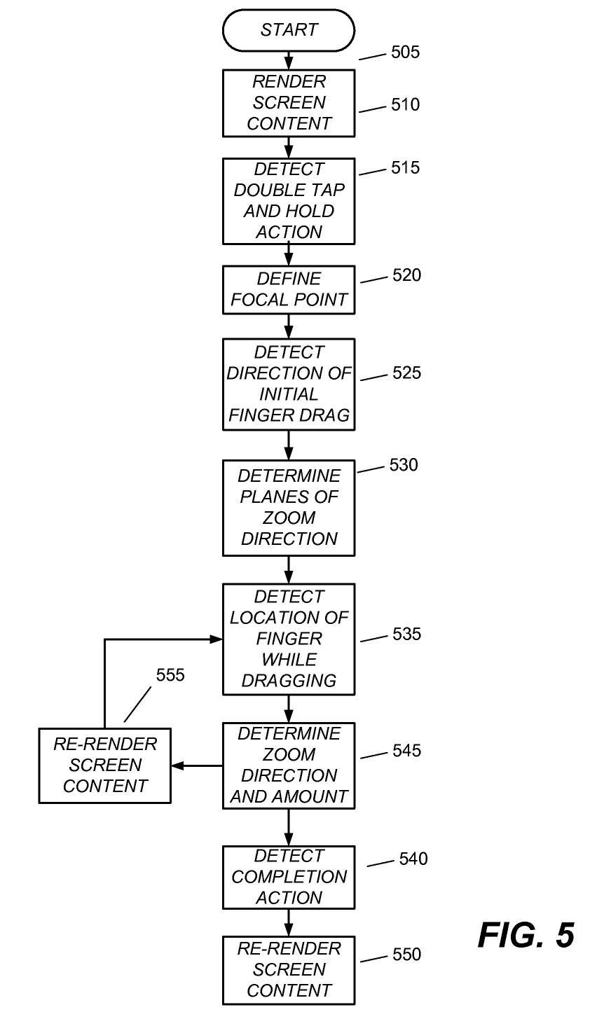

FIG. 5 illustrates one embodiment of an example process for single input variable zoom actions. The process starts 505 by rendering 510 the screen content of the user interface. The zoom module 228 detects 515 a double tap and hold on the touch sensitive screen 130, indicating that the user wishes to make a zoom action. Based on the location of the double tap and hold action on the screen 130, the process defines 520 a focal point to be used in the determination of the amount and direction of zoom. The process further detects 525 the direction of an initial finger drag or zoom gesture across the screen 130. The process uses the focal point and the initial direction of the finger drag to determine 530 a zoom axis, a zoom-in plane, and a zoom-out plane.

As a drag of a finger is detected on the screen 130, the process detects 535 the location of the finger on the screen 130 while dragging, in order to generate a preview of what the zoom will look like if the user released the zoom gesture at that point. The process then determines 545 zoom direction and zoom amount, based on the locations of the focal point and the current location of the point of contact of the finger. The process continually re-renders 555 the screen content based on the updated 535 location of the finger on the screen 130. When the user decides to release their finger and cease the zoom gesture, the process detects 540 the release of the finger from the screen 130 and accordingly determines it as a completion action. The process re-renders 550 the screen content on the screen 130 based on the final zoom direction and zoom amount computed from the initial location and the final location.

The disclosed embodiments beneficially allow a user of a mobile computing device to perform a manual zoom action with only a single finger. The manual zoom action facilitates interaction with user interfaces where the screen content is difficult to view or use because of their small size on the screen. The manual zoom action additionally facilitates changing between modes of visual representation of information. Depending upon the magnitude of zoom, the user interface may display a different information with a different level of granularity. For example, in the situation of a map displayed on the screen, when the map is zoomed out, it may only show highways or other major landmarks such as the outline of a city. When zoomed in, however, the map may add additional detail that was not present in the zoomed out view such as city streets and individual districts within the city. Maps are only one example, however, there are other types of information that may alter their displayed content based on the zoom amount. Thus, not only does the zoom action allow the user interface to scale the screen content, but also to change the screen content that is displayed based on the zoom amount.

Further, the described zoom action requires only a single hand to both hold a mobile computing device while simultaneously performing the described zoom action. This removes the need for more cumbersome two point manual zoom gesture which require a second hand to hold the device while performing the zoom. Additionally, the manual control aspect of the described zoom action is superior to zoom scroll bar or double tap solutions that do not allow the user full control over the zoom function.

### Additional Considerations for Single Point Input Variable Zoom

Some portions of the above describe zoom actions in the context of devices with touch sensitive screens, wherein the zoom action occurs responsive to detected touch interactions. The disclosed embodiments will work with more than merely touch sensitive screens, and the disclosed embodiments cover all user interface situations where a single point input variable zoom action might be required.

In one example embodiment, the screen 130 and the displayed user interface are relatively large in an absolute sense (i.e. on a large screen TV) compared to what their counterparts would look like on a mobile computing device. However, in this example embodiment a user may be standing a large distance (e.g., 4 to 5 meters) from the screen 130 such that the screen content of the user interface appears to be as small as if it were on a mobile computing device held at arm's length. In one example, the screen 130 is large screen TV attached to a computing device, for example a desktop computer or gaming console such as NINTENDO WII (not shown).

In this example embodiment, the screen 130 is not touch sensitive, but rather further comprises motion sensor hardware to detect input sent remotely from the screen. The motion sensor hardware may comprise, for example, an infrared detector that senses and triangulates motion from an external source. In this example embodiment, the touch detection module 310 is configured to accept motion sensor input, and to convert that to the location of a pointer on the screen 130. The zoom module 228 is further configured to accept interactions based on input from the external source and the location of the pointer on the screen. In one embodiment, the input comprises instructions to select an item on the screen, similar to a touch interaction, in a manner consistent with the embodiments described above. Thus, even though the form of input to the screen 130 has changed, the disclosed embodiments handle zoom actions in the same way.

Some portions of the above description describe the embodiments in terms of algorithms and symbolic representations of operations on information, for example, as illustrated and described with respect to FIGS. 3 through 5. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for a single point input variable zoom action through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer implemented method for re-sizing screen content of a user interface displayed within a touch-sensitive screen, the method comprising:
providing, for display on the touch sensitive screen, the screen content comprising an initial view;
detecting an initiating interaction on the touch sensitive screen, the initiating interaction comprising maintaining contact for a predetermined time period with the touch sensitive screen at an initial location;
identifying a focal point, the focal point comprising the initial location of the initiating interaction;
detecting a drag interaction, the drag interaction comprising maintaining contact across the screen in an initial direction;
determining a zoom axis, the zoom axis perpendicular to the initial direction and passing through the initial location of the focal point;
determining a zoom-in plane, the zoom-in plane including a portion of the touch sensitive screen bounded by the zoom axis in the initial direction;
determining a zoom-out plane, the zoom-out plane including a portion of the touch sensitive screen bounded by the zoom axis not in the initial direction;
detecting a release interaction, the release interaction comprising a final location where interaction on the touch sensitive screen is detected;
determining a zoom factor based upon the initial location, the final location, and the initial direction;
generating a zoomed view using the zoom factor, the zoomed view changing a proportion of the screen filled by an area surrounding the initial location of the focal point relative to the initial view; and
providing, for display on the touch sensitive screen, the screen content comprising a zoomed view.

2. The method of claim 1, further comprising
responsive to determining the zoom axis, detecting a second drag interaction comprising constant contact not in the initial direction.

3. The method of claim 1, further comprising
responsive to detecting the drag interaction, providing, for display on the touch sensitive screen, visual feedback on the magnitude of the zoom factor using a location of last detected interaction with the touch sensitive screen.

4. The method of claim 1, wherein the release interaction comprises a removal of contact from the touch sensitive screen.

5. The method of claim 1, wherein the release interaction comprises a removal of contact from the touch sensitive screen for at a minimum period of time.

6. The method of claim 1, wherein the initiating interaction further comprises detecting a single short duration contact with the touch sensitive screen prior to the detection of constant contact.

7. A computer implemented method for re-sizing screen content of a user interface displayed within a touch-sensitive screen, the method comprising:
providing, for display on the touch sensitive screen, the screen content comprising an initial view;
detecting an initiating interaction on the touch sensitive screen at an initial location;
detecting a drag interaction, the drag interaction comprising maintaining contact across the screen in an initial direction;
detecting a release interaction, the release interaction comprising a final location where interaction on the touch sensitive screen is detected;
determining a zoom factor based upon the initial location, the final location, and the initial direction;
generating a zoomed view using the zoom factor, the zoomed view changing a proportion of the screen filled by an area surrounding the initial location relative to the initial view; and
providing, for display on the touch sensitive screen, the screen content comprising a zoomed view.

8. The method of claim 7, further comprising:
determining a zoom axis, the zoom axis perpendicular to the initial direction and passing through the initial location;
determining a zoom-in plane, the zoom-in plane including a portion of the touch sensitive screen bounded by the zoom axis in the initial direction;
determining a zoom-out plane, the zoom-out plane including a portion of the touch sensitive screen bounded by the zoom axis not in the initial direction;

9. The method of claim 7, further comprising
responsive to detecting the drag interaction, detecting a second drag interaction comprising constant contact with the touch sensitive screen not in the initial direction.

10. The method of claim 7, further comprising
responsive to detecting the drag interaction, providing, for display on the touch sensitive screen, visual feedback on the magnitude of the zoom factor using a location of last detected interaction with the touch sensitive screen.

11. The method of claim 7, wherein the release interaction comprises a removal of contact from the touch sensitive screen.

12. The method of claim 7, wherein the release interaction comprises a removal of contact from the touch sensitive screen for at least a minimum period of time.

13. A computer readable medium configured to store instructions, the instructions when executed by a processor cause the processor to:
provide, for display on the touch sensitive screen, screen content of a user interface comprising an initial view;
detect an initiating interaction on the touch sensitive screen at an initial location;
detect a drag interaction, the drag interaction comprising maintaining contact across the screen in an initial direction;
detect a release interaction, the release interaction comprising a final location where interaction on the touch sensitive screen is detected;
determine a zoom factor based upon the initial location, the final location, and the initial direction;
generate a zoomed view using the zoom factor, the zoomed view changing a proportion of the screen filled by an area surrounding the initial location relative to the initial view; and
provide, for display on the touch sensitive screen, the screen content comprising a zoomed view.

14. The computer readable medium of claim 13, further comprising instructions that cause the processor to
determine a zoom axis, the zoom axis perpendicular to the initial direction and passing through the initial location;
determine a zoom-in plane, the zoom-in plane including a portion of the touch sensitive screen bounded by the zoom axis in the initial direction;
determine a zoom-out plane, the zoom-out plane including a portion of the touch sensitive screen bounded by the zoom axis not in the initial direction;

15. The computer readable medium of claim 13, further comprising instructions that cause the processor to
responsive to the detection of a drag interaction, detect a second drag interaction comprising constant contact with the touch sensitive screen not in the initial direction.

16. The computer readable medium of claim 13, further comprising instructions that cause the processor to
responsive to the detection of the drag interaction, provide, for display on the touch sensitive screen, visual feedback on the magnitude of the zoom factor using a location of last detected interaction with the touch sensitive screen.

17. The computer readable medium of claim 13, wherein the release interaction comprises a removal of contact from the touch sensitive screen.

18. The computer readable medium of claim 13, wherein the release interaction comprises a removal of contact from the touch sensitive screen for at least a minimum period of time.
